(19) United States
(12) Patent Application Publication
(10) Pub. No.: US 2014/0151979 A1
(43) Pub. Date: Jun. 5, 2014

(54) Fifth Wheel Backup Camera System and Method

(71) Applicant: Fontaine Fifth Wheel, Trussville, AL (US)

(72) Inventors: Aaron Puckett, Vinemont, AL (US); Robert Laney, Kimberly, AL (US)

(73) Assignee: Fontaine Fifth Wheel, Trussville, AL (US)

(21) Appl. No.: 14/077,905

(22) Filed: Nov. 12, 2013

Related U.S. Application Data
(60) Provisional application No. 61/732,661, filed on Dec. 3, 2012.

(51) Int. Cl. B60D 1/36

(52) U.S. Cl. CPC B60D 1/36
USPC 280/477

(57) ABSTRACT

A system for facilitating coupling between a trailer kingpin and a fifth wheel of a vehicle includes at least one camera mounted on the vehicle and adapted to provide an image of the kingpin. A monitor is in communication with the camera and is adapted to display the image of the kingpin.

### CLAIM OF PRIORITY

This application claims priority to U.S. Provisional Patent Application No. 61/732,661, filed Dec. 3, 2012, the contents of which are hereby incorporated by reference.

### FIELD THE INVENTION

The present invention relates generally to systems and methods for coupling the kingpins of trailers to the fifth wheels of towing vehicles such as tractor trucks and in particular, to camera-based display system for facilitating such couplings.

### BACKGROUND

Towing vehicles, such as tractor trucks or semis and the like, are equipped with fifth wheel hitches which receive and engage the kingpins of trailers. The fifth wheel is positioned on the back of the tractor truck and features a hitch plate having a central throat equipped with a latching mechanism winch engages the kingpin. The throat may he for example provided with an open end facing the rear of the truck. The kingpin extends downward from the underside of the leading end portion of the trailer. The engagement of the trailer kingpin by the fifth wheel is the primary means by which the trailer is pivotally connected to the tractor truck.

Prior to hauling a load, the tractor truck must be coupled to the trailer containing the load. This is accomplished by backing the fifth wheel of the tractor truck towards and under the leading end portion of the trailer so that the trailer kingpin passes horizontally through the open end of the throat and into the throat of the fifth wheel, where it is engaged by a knelling mechanism. In order to perform this maneuver, the truck driver must make sure that the kingpin is at the proper vertical height and horizontal position with respect to the fifth wheel. This may turn into a trial and error proposition as the driver is required to adjust the height of the trailer vertical support if the initial configuration is incorrect. Such an approach results in wasted time and driver frustration for the coupling attempts made when the trailer kingpin is at the wrong height. Furthermore, the driver must exercise great caution when backing the truck so that the coupling occurs at a very low speed, otherwise, damage to the fifth wheel and kingpin could result. Even terminal tractor applications, where the fifth wheel is mounted on a boom, require at least some proper positioning of the kingpin. A need exists for a system and method that addresses the above issues and facilitates the coupling of the trailer kingpin and the tractor truck fifth wheel.

### BRIEF DESCRIPTION OF THE DRAWINGS

FIGS. 1A-1C are side diagram views illustrating a tractor truck fifth wheel being coupled with a trailer kingpin in accordance with an embodiment of the system and method of the present invention;

FIG. 2 is a top perspective view illustrating the rear portion of the tractor truck of FIGS. 1A-1C equipped with an embodiment of the backup camera system of the invention and a fixed fifth wheel;

FIG. 3 is a top perspective view illustrating the rear portion of the tractor truck of FIGS. 1A-1C equipped with an embodiment of the backup camera system of the invention and a sliding fifth wheel;

FIG. 4 is a schematic illustrating the components of a first embodiment of the backup camera system of the present invention;

FIG. 5 is a schematic illustrating the components of a second embodiment of the backup camera system of the present invention;

FIG. 6 is a flow chart illustrating processing performed by the controller/processor of FIG. 5 in accordance with an embodiment of the method of the present invention;

FIG. 7 illustrates an example of the screen display provided by the cab display of FIG. 4 or 5;

FIG. 8 is a schematic illustrating the components of a third embodiment of the backup camera system of the present invention.

### DETAILED DESCRIPTION OF EMBODIMENTS

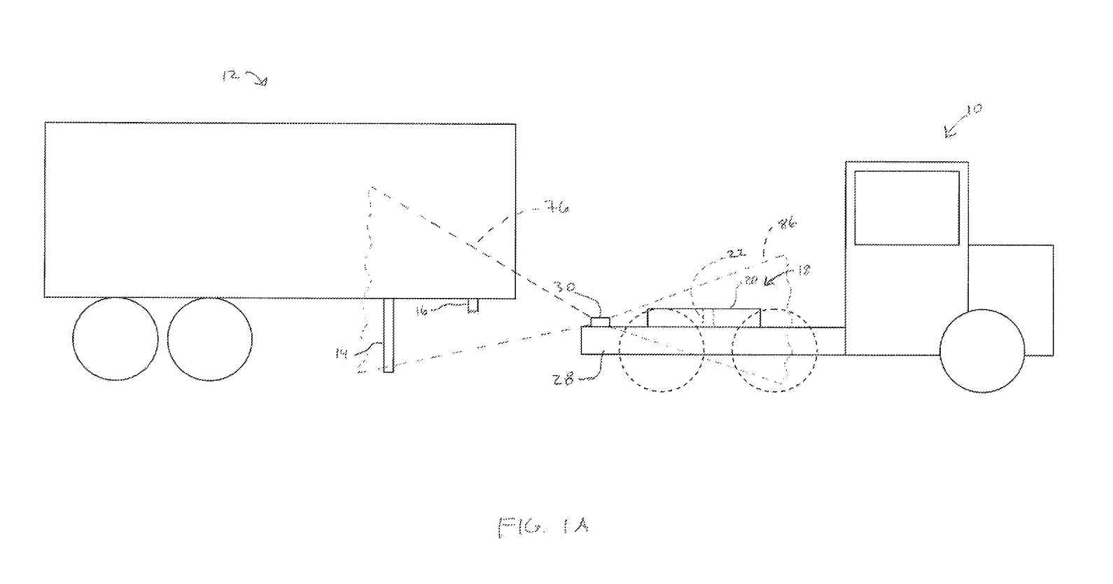

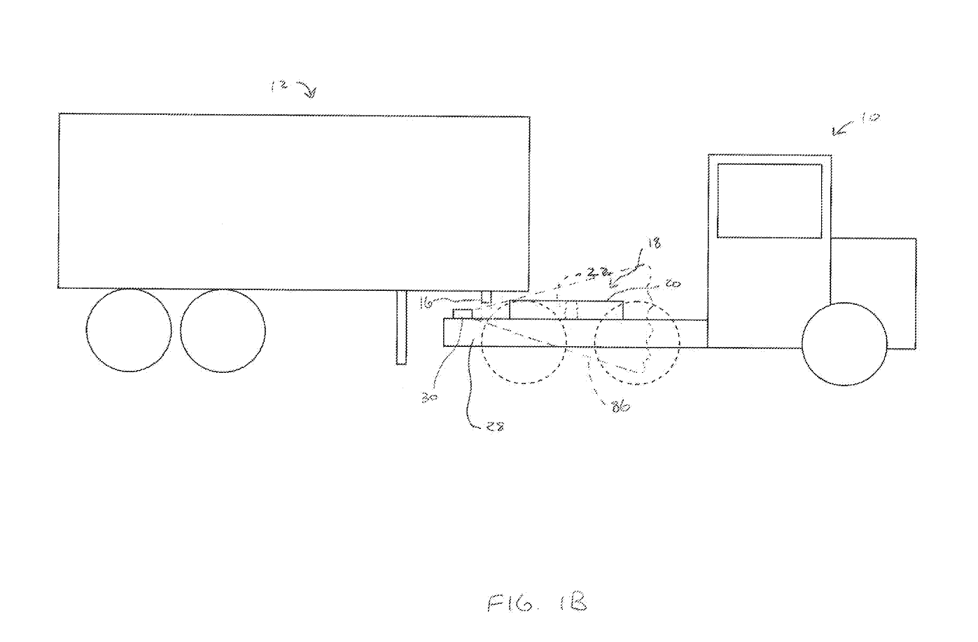

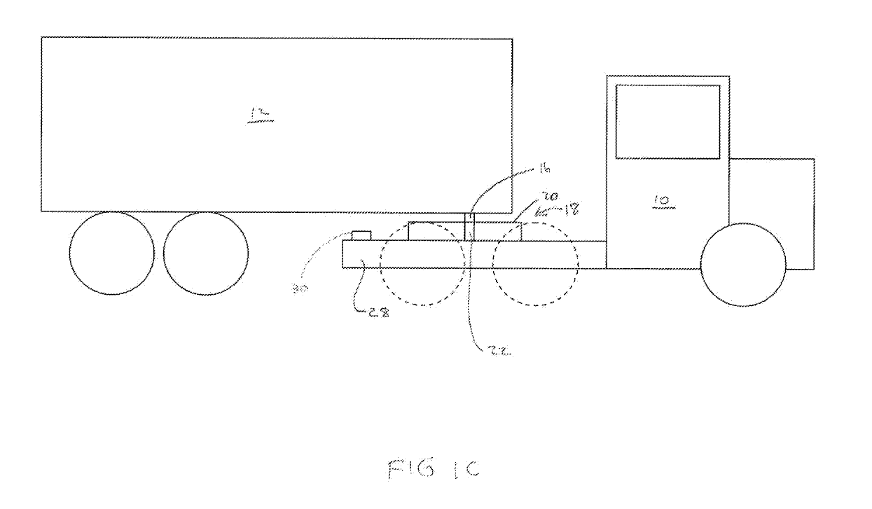

In accordance with an embodiment of the system and method of the present invention, as illustrated in FIG. 1A, a towing vehicle, such as a tractor truck indicated in general at 10, is positioned to begin the coupling process with regard to a trailer, indicated in general at 12. While the invention is described below in terms of a tractor truck being used as the towing vehicle and a semitrailer being used as the trailer, it is to be understood that the present invention could be applied to other towing vehicle and trailer arrangements.

As illustrated in FIGS. 1A-1C, and as known in the art, the trailer 12 features at vertical support 14 and a kingpin 16. The truck is provided with a fifth wheel hitch, indicated in general at 18, having a hitch plate 20 and a throat 22.

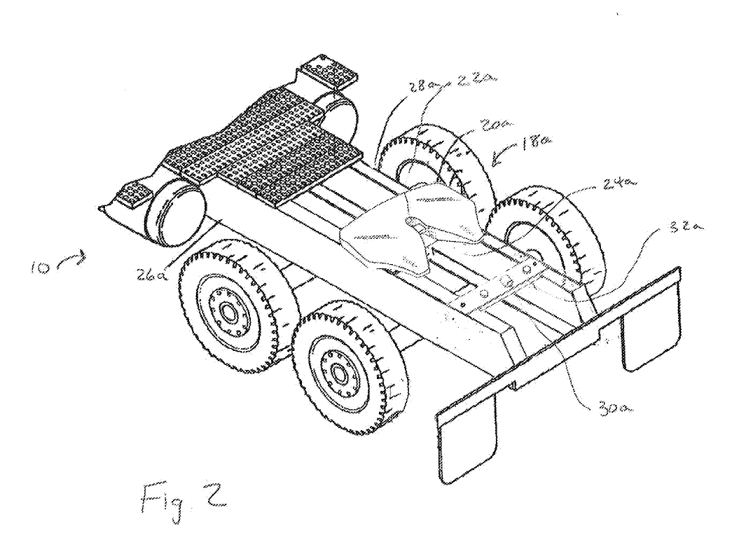

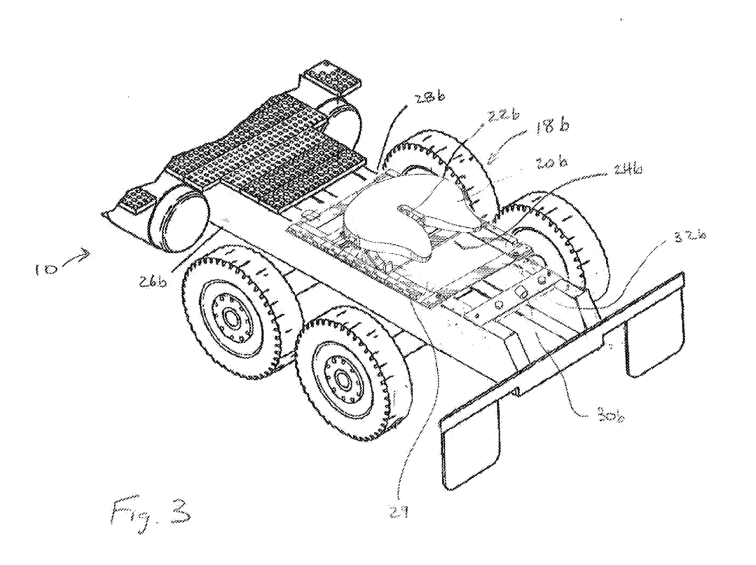

Enlarged views of embodiments of the fifth wheel hitch are provided in FIGS. 2 and 3. where the fifth wheel is indicated at 18a and 18b, respectively. In both embodiments, the fifth wheel hitch plate is provided with a rearward facing, generally V-shaped opening (24a in FIG. 2 and 24b in FIG. 3). As known in the art, the fifth wheel throats 22a and 22b are provided with latching mechanisms that automatically and/or manually engage and lock the trailer kingpin within the throat of the fifth wheel to couple the trailer to the tractor truck.

In FIG. 2, the fifth wheel 18a is mounted in a fixed fashion on truck frame rails 26a and 28a. In FIG. 3, the fifth wheel 18b is mounted on truck frame rails 26b and 28b via a sliding mechanism 29 so that the fore and aft position of the fifth wheel on the truck frame rails may be adjusted. An example of such a mechanism is disclosed in commonly owned U.S. Pat. No. 5,765,849 to Moulton et al., the contents of which are hereby incorporated by reference.

In accordance with the present invention, the tractor truck 10 of FIGS. 1A-1C is also provided with a camera 30 mounted on the rear portion of the truck frame so as to be positioned between the fifth wheel 18 and the trailer kingpin 16. More specifically, as illustrated in FIGS. 2 and 3, the camera is preferably mounted via a camera cross member bracket 32a (FIG. 2) or 32b (FIG. 3) that extends between, and is fastened to (such as by bolts or welding) the rearward portions of truck frame rails 26a or 26b and 28a or 28b. Of course, other locations on the rear portion of the truck frame, or on the tractor truck in general, may be used for mounting the camera 30. The camera 30 is positioned such that the trailer kingpin 16 may pass above or beside the camera during coupling of the trailer to the tractor truck.

The camera 30 (or 30a and 30b) preferably is of the type that ma be used to view in both the forward direction (i.e. towards the cab of the truck) and the rearward direction of the truck (i.e. towards the trailer) and has night vision capability in both viewing directions. In addition, to protect against debris, the camera preferably is of the type that has shutters that cover the forward facing lens and the rearward facing lens that open when the camera is in use. As an example only, a suitable camera is the model DE-8093R available from Vise Electronics Co., Ltd, of Guang Dong, China. In some embodiments, two such cameras may be used with one facing forward and one facing rearward. Alternatively, or in addition, the camera or cameras 30 may be mounted in a housing that has a clear front side and a clear rear side.

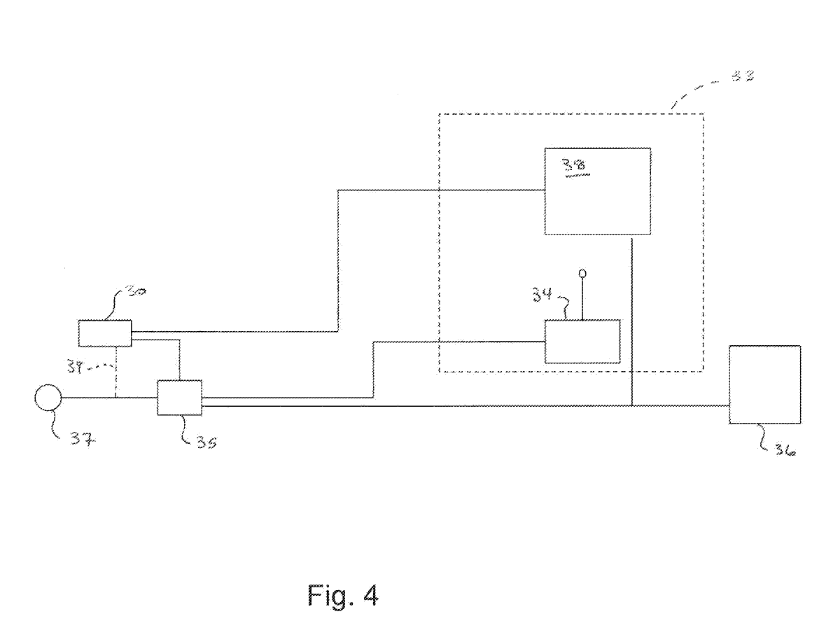

In a preferred embodiment of the invention, the camera of the system is activated when the transmission of the truck is shifted into reverse. More specifically, with reference to FIG. 4, the cab of the truck, indicated in phantom at 33, features a transmission gear shifter or selector 34, as is known in the art. When the truck is shifted into reverse gear, a backup light relay 35 permits electricity from the truck electrical power system 36 to flow to backup lights 37 so that they are illuminated. The relay 35 also directs power to the system camera 30 so that it is activated. Alternatively, the camera may tap directly into the backup lamp power line, as indicated by dashed line 39 of FIG. 4. The image from the camera 30 is displayed in the cab via monitor or display 38. The monitor 38 may optionally contain a controller or processor for processing the images received from the camera(s). The camera 30 may include only a rearward facing camera with a corresponding image displayed on the monitor 38. Alternatively, the camera 30 may include both forward and rearward looking lenses or cameras with a corresponding split-screen or picture-within-picture display provided on the monitor 38, with one image from the forward facing camera, and one image taken from the rearward facing camera. As an example only, the monitor or display may be a VOYAGER model AOM-7694 monitor available from ASA Electronics Corporation of Elkhart, Ind.

When the transmission gear selector 34 is moved into the drive or neutral positions, the relay 35 deactivates the truck backup lights and the camera 30.

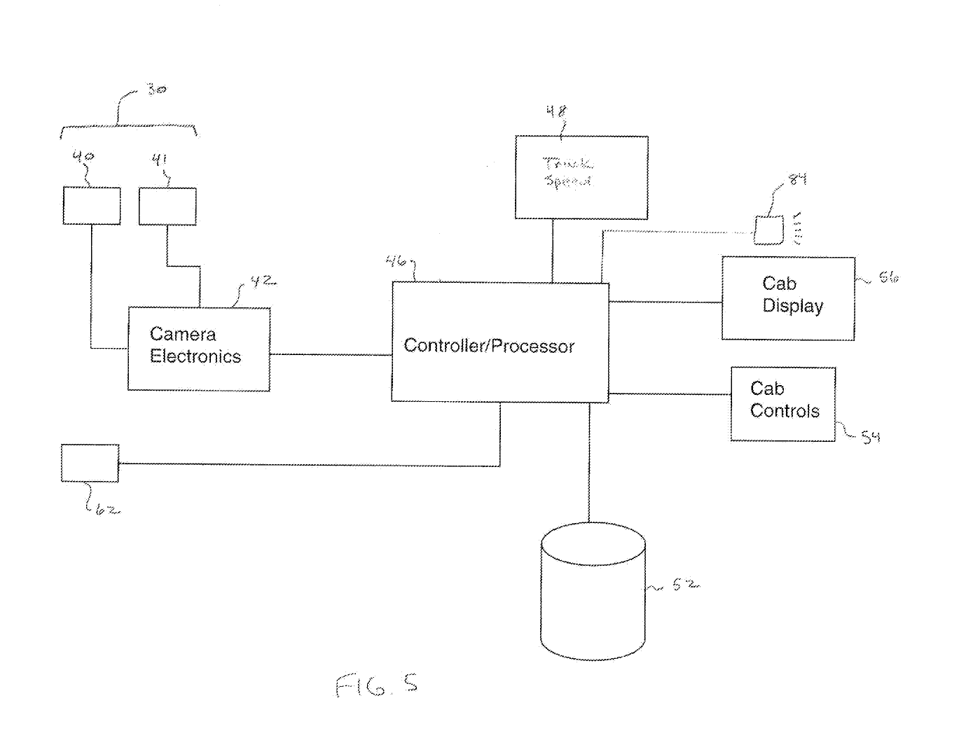

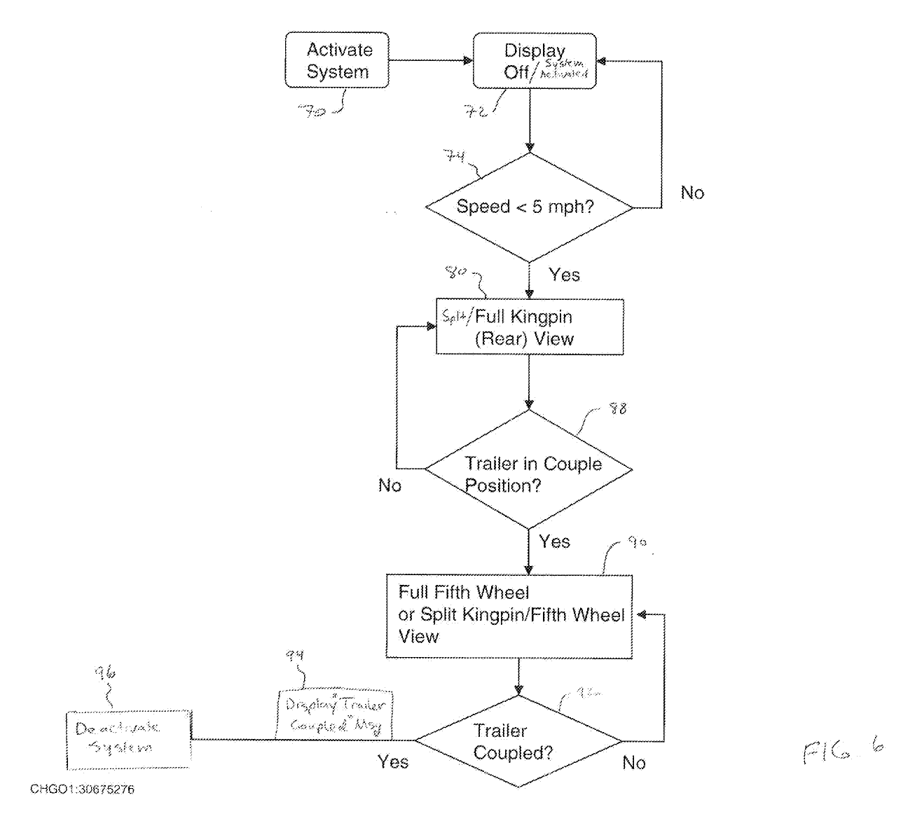

In an alternative embodiment, illustrated in FIGS. 5 and 6, camera electronics 42 communicate with camera 30, which takes the form of a rearward facing camera 40 and forward facing camera 41

As illustrated in FIG. 5, the camera electronics 42 communicate with a system controller or processor 46, which is mounted in a secure and protected location on the truck, such as under or behind the driver or passenger seat or in a weatherproof housing elsewhere on the truck. The system processor 46 may he a microprocessor or any other suitable electronic device known in the art. The camera electronics may communicate with the system processor 46 by a wire connection or a wireless connection. The system processor 46 communicates with a source 48 that provides the truck speed. This may be a global positioning system (GPS) system, the original equipment manufacturer (OEM) truck computer or any other system or source that is capable of providing the truck speed to the system processor. In addition, the system processor 46 communicates with a database 52. The purpose and functionality of these connections will be described below. The system is powered by the battery of the tractor truck (but may have its own dedicated battery or other power source) and is controlled by controls 54 that are also connected to the system controller 46 and positioned within the cab of the truck for ease of access by the driver. A cab monitor or display 56 communicates with the controller and is positioned within the cab of the truck in a position that provides easy viewing by the driver.

As illustrated in FIG. 5, a distance sensor 62 also communicates with the system controller 46. The distance sensor 62 may mounted above or adjacent to the throat of the fifth wheel. Alternatively, the distance sensor may he mounted to the camera cross member bracket (32a or 32b in FIGS. 2 and 3) or anywhere else on the truck frame, fifth wheel assembly or tractor truck in general. The use and functionality of the distance sensor will he described below.

The system controller 46 of FIG. 5 is programmed to provide the functionality illustrated in FIG. 6. This functionality will now he described with respect to FIGS. 1A-1C.

In FIG. 1A, the truck is in position to begin the coupling process. As indicated at 70 in FIG. 6, the driver may use the system cab controls 54 (FIG. 5) to activate the system. As indicated at 72 in FIG. 6 the cab display (56 in FIG. 5) initially remains off or provides a “system activated” message. Alternatively, the sensor 62 could activate the system and camera at 70 when it detects the kingpin, or once the system is activated by the driver, the sensor 62 could activate the camera when it detects the kingpin.

The system processor next checks, via the truck speed source (48 of FIG. 5), to determine if the truck speed is less than for example, five miles per hour (74 in FIG. 6). If not, the cab display remains off or continues to provide the system activated message with no visual feed from the system cameras. Of course speeds other than five miles per hour could be used as the threshold for activating the camera. This optional feature may be omitted in alternative embodiments of the system so that the truck speed source 48 of FIG. 5 is not required, and the camera is activated when the sensor 62 detects the kingpin or the driver uses the system cab controls or truck transmission gear shifter to activate the system.

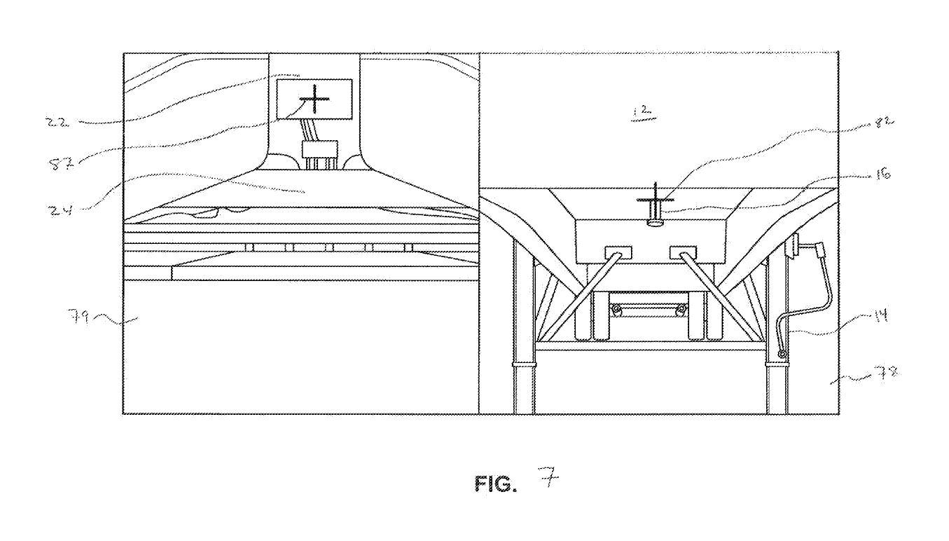

If the truck speed is less than, for example, five miles per hour (74 of FIG. 6) the rearward facing camera 40b of FIG. 5 is activated by system processor 46 (80 in FIG. 6) to provide the driver with a view of the trailer kingpin, as illustrated at 76 in FIG. 1A, via the cab display. More specifically, the cab display shows a visual image from the rearward facing camera such as the one illustrated at 78 in FIG. 7. The forward facing camera 40a of FIG. 5 may also be activated (simultaneously with camera 40b) at step 80 of FIG. 6 to provide the image 79 of the fifth wheel throat on the left side of the screen of FIG. 7. Alternatively, the right half image 78 of the screen in FIG. 7 may be provided full screen (with the forward facing camera remaining off).

Next, as illustrated at step 88 in FIG. 6, the system checks if the trailer kingpin is in the correct position to couple. More specifically, as illustrated in FIG. 7, the image displayed On the system cab display includes a marking or cursor such as crosshair 82. Of course alternative marking or cursor shapes may be used, including, but not limited to, multiple markings, scales and other indicators.

In one embodiment, the position of the camera and the calibration of the crosshair symbol is such that the center of the crosshair 82 should be at the base of the trailer kingpin 16 (as shown in FIG. 7) when the fifth wheel is at a predetermined distance from the kingpin for the kingpin to be at the correct height for proper coupling with the truck fifth wheel. This predetermined distance is detected by the sensor 62 of FIG. 5 and sent to the system processor, which provides an audible signal (via audio device 84 of FIG. 5) within the cab of the truck or a visual indication on the cab display (56 of FIG. 5). If the crosshair 82 is above or below the base of the trailer kingpin at this point, the driver must get out of the cab and adjust the vertical trailer support 14 accordingly.

In an alternative embodiment, at step 88 of FIG. 6, the sensor 62 detects if the kingpin is at the proper height for coupling and alerts the driver, such as a visual indicator via the display 56 of FIG. 5 and/or an audible signal via the audio device 84 of FIG. 5, if the kingpin is too high or too low for coupling.

In addition, during step 88 of FIG. 6, in either of the above embodiments, the vertical portion of the crosshair 82 should be approximately overlaying the vertical longitudinal axis of the kingpin 16 (as shown in FIG. 7) for the truck to be in the correct horizontal position for coupling. If this is not the case, the driver must move the truck to obtain the correct horizontal positioning. The sensor 62 may also optionally provide a visual or audible signal if the horizontal position of the kingpin is not in alignment with the fifth wheel.

Once the trailer kingpin height and horizontal truck position is correctly adjusted (step 88 of FIG. 6), the driver may back the truck fifth wheel up under the trailer. With reference to step 90 of FIG. 6, when the driver reaches the couple position, such as the one illustrated in FIG. 1B, as detected by the sensor 62 (FIG. 5), the forward facing camera 40a of FIG. 5 is automatically activated (in embodiments where it has not already be activated), as illustrated at 86 in FIGS. 1A and 1B to provide the driver with a view of the trailer throat (79 of FIG. 7) in either a full or split display mode. The view provided by the forward facing camera also includes a marking or cursor such as crosshairs 87, which the driver may line up on the back of the fifth wheel throat and the kingpin as the coupling process is completed.

As indicated at 92 in FIG. 6, at least the forward facing camera stays on to provide a view of the fifth wheel throat and corresponding crosshair until the trailer is coupled, as detected by distance sensor 62 (FIG. 5) and controlled by the system processor 46. The driver then performs a visual inspection to determine that the trailer has been safely coupled. Once this is done, the driver may deactivate the system (step 96 of FIG. 6).

As an option in the present invention, when the distance sensor detects that the trailer has been coupled, as illustrated in FIG. 1C, the system processor displays a “trailer coupled” message (94 in FIG. 6) via the cab display, and the system is deactivated (step 96 of FIG. 6). In this embodiment, however, the driver still must perform a visual inspection to determine that the trailer has been safely coupled. Of course the system may alternatively be configured so that the driver must deactivate the system (step 96 of FIG. 6) alter performing the visual inspection for proper coupling.

As noted previously, the system is provided with a database 52 (FIG. 5). This database can store data logs of coupling attempts and successes for training or other purposes.

In an alternative embodiment of the system, the distance sensor 62 of FIG. 5 may be omitted. In this embodiment, the driver relies on other means to indicate the correct distance between the fifth wheel and kingpin at which the cursor (82 of FIG. 7) from the rearward facing camera should be compared to the kingpin vertical position. This may be, for example, when the kingpin is positioned vertically over the truck frame trailing edge or some other indicator on the truck. Alternatively, the appropriate spacing may be marked on the parking lot surface upon which the coupling is performed. In addition, in this embodiment, the driver manually selects which views he wants to appear on the cab display: rearward camera/kingpin view only, forward camera/fifth wheel throat view only, or a combination of the two the split screen of FIG. 7).

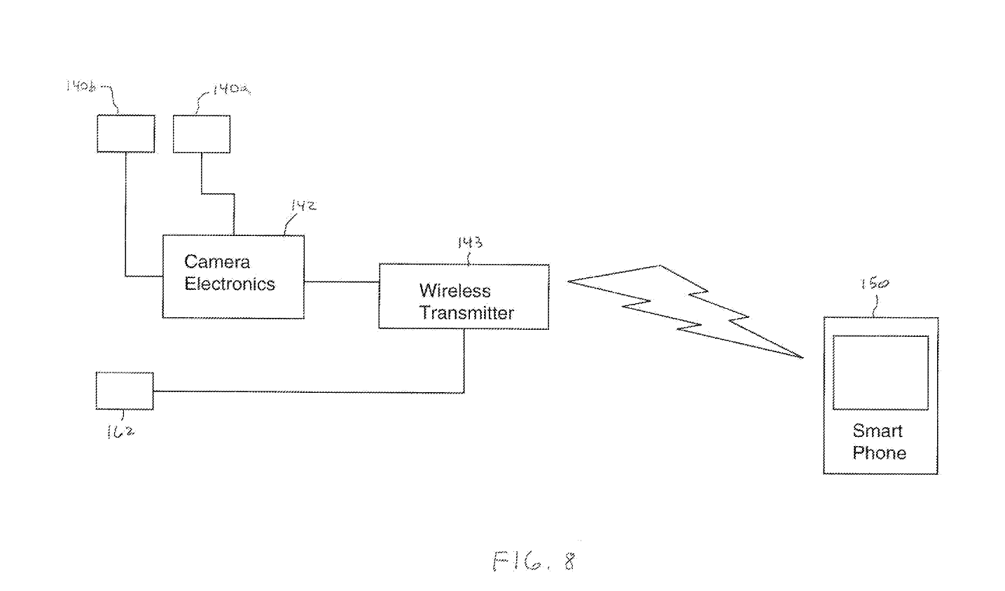

As illustrated in FIG. 8, in still another embodiment of the system of the present invention, the camera electronics 142 receive inputs from forward facing and rearward facing 140a and 140b, respectively, and feed them to a wireless transmitter 143. In addition, the signal from a distance sensor 162 is directed to the wireless transmitter 143. The cameras and distance sensor of FIG. 8 are mounted in positions similar to those of cameras 40a and 40b and sensor 62 of FIG. 5.

Wireless transmitter 143 of FIG. 8 transmits data from cameras 140a and 140b and sensor 162 to a wireless receiver device 150, such as a personal digital assistant (PDA), personal access display device (PADD), smart phone or the like, which serves the functions of processor 46, cab controls 54 and cab display 56 of FIG. 5. The wireless receiver device May also function as the cab audible signal device 84. In addition, the wireless receiver device 150 has GPS capability to perform the function of truck speed source 48 of FIG. 5.

While the preferred embodiments of the invention have been shown and described, it will be apparent to those skilled in the art that changes and modifications may be made therein without departing from the spirit of the invention, the scope of which is defined by the appended

What is claimed is:

1. A system for facilitating coupling between a trailer kingpin and a fifth wheel comprising
a. a rearward facing camera adapted to be mounted to the vehicle in a position to provide an image of the kingpin
b. a display in communication with the rearward facing camera and adapted to display the image of the kingpin.

2. The system of claim 1 wherein the vehicle includes a pair of generally parallel frame rails and further comprising a bracket attached to and extending between the pair of frame rails and wherein the camera is mounted to the bracket.

3. The system of claim 1 wherein the vehicle has and electrical power system, a transmission gear shifter and further comprising a relay in communication with the rearward facing camera, the transmission gear shifter and the vehicle electrical power system, said relay providing electrical power from the vehicle electrical power system to the rearward facing camera when the transmission gear shifter is moved into a reverse gear position.

4. The system of claim 3 wherein the vehicle has a backup light and the relay provides electrical power from the vehicle electrical power system to the backup light to illuminate the backup light when the transmission gear shifter is moved into a reverse gear position, wherein the rearward facing camera is also powered when the transmission gear shifter is moved into the reverse gear position.

5. The system of claim 1 further comprising a forward facing camera adapted to provide an image of the fifth wheel and wherein the display is also in communication with the forward facing camera so that images from the rearward facing camera and the forward facing camera may be displayed.

6. The system of claim 5 wherein the display includes a monitor that is adapted to display images from the forward facing camera and the rearward facing camera simultaneously.

7. A system for facilitating coupling between a trailer kingpin and a filth wheel comprising:
a. a rearward facing camera adapted to provide an image of the kingpin;
b. a forward facing camera adapted to provide an image of the fifth wheel;
c. a display;
d. a controller in communication with the forward and rearward facing cameras and the display, said controller programmed to display images from the forward and rearward facing cameras on the display.

8. The system of claim 7 wherein the fifth wheel is positioned on a truck having a cab and the display is adapted to be positioned within the cab of the truck.

9. The system of claim 7 further comprising a distance sensor in communication with the controller.

10. The system of claim 7 wherein the controller provides a marking on the displays from the forward and rearward facing cameras.

11. The system of claim 7 further comprising a database in communication with the controller.

12. The system of claim 7 further comprising a source of truck speed in communication with the controller.

13. The system of claim 12 wherein source of truck speed is a global positioning system.

14. The system of claim 12 wherein the source of truck speed is the truck computer.

15. The system of claim 7 wherein the system controller is a wireless receiver device.

16. The system of claim 15 wherein the wireless device is a personal digital assistant.

17. The system of claim 7 wherein the system controller is a microprocessor.

18. The system of claim 7 wherein the forward and rearward facing cameras have night vision capability.

19. A method of facilitating coupling a trailer kingpin to a fifth wheel of a vehicle comprising the steps of:
a. displaying a view of the kingpin to a driver of the vehicle;
b. displaying a marking on the kingpin view of step a.;
c. displaying a view of the fifth wheel to the driver of the vehicle.

20. A method of coupling a trailer kingpin to a fifth wheel of a vehicle comprising the steps of:
a. viewing a display showing an image of the kingpin:
b. viewing a marking on the display of step a.;
c. adjusting the height of the kingpin;
d. backing the vehicle and fifth wheel towards the trailer kingpin;
e. viewing a display showing an image of the fifth wheel;
f. coupling the kingpin to the fifth wheel.
